(19) United States
(12) Patent Application Publication
(10) Pub. No.: US 2019/0019209 A1
(43) Pub. Date: Jan. 17, 2019

(54) Electronic Promotion System and Method

(71) Applicants: Tao Xu, Westmont, IL (US); Jin Tian, Westmont, IL (US)

(72) Inventors: Tao Xu, Westmont, IL (US); Jin Tian, Westmont, IL (US)

(21) Appl. No.: 15/651,613

(22) Filed: Jul. 17, 2017

(51) Int. Cl. G06Q 30/02; G06K 7/10

(52) U.S. Cl. CPC G06Q 30/0222; G06K 7/10722

(57) ABSTRACT

An electronic, computer-implementable promotion system and methodology communicate promotional content to consumers by way of a computer-implementable application implementable via a consumer computer and a computer-based data-processing environment. The consumer computer is necessarily in communication with a camera and implements a client-sided version of the computer-implementable application. The computer-based data processing environment is in communication with an information database and implements a server-sided version of the computer-implementable application. At least one retail package is outfitted with a photographable coded image having entry-identification information. The camera operates to photograph the image for providing a digital image photograph, and the consumer computer communicates the entry-identification information to the computer-based data processing environment via the digital image photograph, which compares the entry-identification information to the information database for determining whether the entry-identification information is outfitted upon a winning entry piece.

### BACKGROUND OF THE INVENTION

### Field of the Invention

This disclosure is generally directed to electronic commerce (e-commerce) systems and media platforms, and more particularly to an electronic promotional system for providing promotions to incentivize customers to purchase goods and/or services in a networked, mobile communications environment.

### Brief Description of the Prior Art

U.S. Pat. No. 8,366,544 ('544 patent), issued to Walker et al., discloses a Method and Apparatus for Facilitating a Promotion. The '544 patent describes a method and apparatus for conducting a promotion and for distributing promotions to potential users provide a merchant or promotion organizer flexibility in the way they conduct the promotion as well as an ability to change one or more aspects of the promotion during the operation of the promotion. In accordance with one embodiment, such a promotion may provide for a game on a mobile device, wherein a locked outcome of the game may be unlocked using an unlock code. In one embodiment, a result of the locked outcome may correspond to an intra-game benefit.

U.S. Pat. No. 8,775,243 ('243 patent), issued to Gillenson et al., discloses an electronic coupon creation deployment, transference, validation management, clearance, redemption and reporting system. The '243 patent describes an e-commerce system for use with both mobile and non-mobile systems, to deploy virtual advertising and promotion via the use of electronic coupons, and more particularly a method and system for creating, deploying, transferring, clearing, managing, redeeming and reporting on the use of electronic coupons or virtual electronic rebates and permitting individuals and groups within one or more social communications networks to participate in and transmit information to others about their activities related to the virtual advertising, incentives, redemption and promotion.

U.S. Pat. No. 9,424,718 ('718 patent), issued to Guziel, discloses a Symbol Match Apparatus and Method for a Game. The '718 patent describes a method and apparatus of aggregating a randomly distributed number of symbol images to a population of consumers using mobile communication devices to scan consumer products or promotional messages. The virtual game card puzzles on the communication devices are populated by the symbols in an order to complete a card and earn a prize or an entry for a drawing to win a prize.

U.S. Pat. No. 9,466,067 ('067 patent), issued to Tabor et al., discloses a Mobile Promotion Distribution system. The '067 patent describes certain systems and methods for providing games, challenges, and/or promotions to mobile devices as a primary means for providing incentives to customers. The system can be operable to receive location information associated with a mobile device and additional information, such as but not limited demographic and/or purchase history information, associated with the mobile device. Additionally, the system can be operable to select content based on the received information, transmit the content to the mobile device, receive an event outcome indicator associated with the content, and provide a promotional offer to the mobile device.

U.S. Pat. No. 9,578,107 ('107 patent), issued to Boncyk et al., discloses a Data Capture and Identification System and Process. The '107 patent describes an identification method and process for objects from digitally captured images thereof that uses data characteristics to identify an object from a plurality of objects in a database. The data is broken down into parameters such as a Shape Comparison, Grayscale Comparison, Wavelet Comparison, and Color Cube Comparison with object data in one or more databases to identify the actual object of a digital image.

United States Patent Application Publication No. 2015/0026785 authored by Soon-Shiong describes certain systems, methods, and use-cases of multi-modal authentications and content distribution. A content consumer can capture a multi-modal digital representation of multiple objects where a juxtaposition of features derived from the digital representation can be used to recognize that at least some of the objects are a valid authentication object. Upon authentication, an authentication agent determines a content access level for content associated with the corresponding to the juxtaposition. The content can then be presented on an electronic device, possibly within a secure virtual machine, according to the content access level.

United States Patent Application Publication No. 2016/0180396 authored by Devolites describes a system and method for registration and delivery of mobile promotion such as advertising and/or publicity. Various embodiments are directed to a system, method and/or a computer program product including a computer-implemented method of registering a user with a mobile promotion service provider system can include: receiving, by at least one computer processor, a selection of a registration request for at least one brand at a mobile device; transmitting, by the at least one computer processor, the registration request to a server; and receiving, by the at least one computer processor, from the server an updated configuration file including confirmation of the registration request, at the mobile device.

United States Patent Application Publication No. 2016/0171530 authored by S a et al. describes certain exemplary methods, apparatuses, and systems for generating a graphical user interface (GUI) including a plurality of selectable elements. Selections of an application and a first filter within the GUI configure the promotion to be displayed to a subset of a selected group of users, the subset being users that access the network service using a user device that both runs the selected application and meets user device state criteria defined by the selected first filter. A request corresponding to the first filter is transmitted to a user device detected to be running the selected application and associated with the selected group of users. When the user device is determined to satisfy the user device state criteria, the promotion is transmitted to the user device.

United States Patent Application Publication No. 2016/0196568 authored by Song describes a method and system for providing a promotion platform of a mobile application, the method including registering mobile applications, and providing a compensation corresponding to a user entry to a service provider of a first application in response to a user entering a promotion platform through a user interface provided from the first application, wherein the user having entered the promotion platform through the user interface provided from the first application receives, from a second application, the compensation in response to performing an operation designated in a promotion of the second application displayed through the promotion platform.

### SUMMARY OF THE INVENTION

In distinction to the prior art, the present invention basically provides an electronic promotion or gaming system that incorporates coded imagery on retail packaging for promotional gaming purposes. The system and method according to the present invention provide a completely new platform that revolutionarily changes the traditional way purchase-related promotion games are played by allowing complete flexibility in game design and administration, greatly reducing the possibility of illegal or fraudulent play, lowering the cost of game implementation, and delivering game performance information.

Noting that retail packages are often printed with graphics that include product image, company/brand logo, product description, etc., the present invention contemplates embedding non-visible and non-duplicable codes into either the logo or product image for further electronic or computer-based processing via computer networks currently exemplified or typified by the so-called cloud networking environment. The invention thus enables a new kind of web-based product promotion that allows companies/brands to provide purchase-based (1) instant prize win games (2) event promotional games and (3) royalty programs.

More specifically, retail packages are printed or otherwise outfitted with coded imagery, which can either be a product image or brand logo, and a unique identification or ID. The ID is different for every package, as a part of the complete graphical layout printed on the package. In addition to the coded image and an ID on the package, there are preferably at least two servers configured for governing promotional content delivery. A first of the servers may be referred to as a game server, which server is used for defining the game rules and parameters and the prizes, running the games, storing all the registered customers, recording game participation, generating marketing data, etc. A second of the servers may be referred to as an authentication server at which all imagery involved in game play is validated or otherwise scrutinized for authenticity and thus provides a layer of added security to the system and methodology.

Once the promotion or game is configured, every outfitted retail package can potentially become a winning ticket or winning entry piece and/or counted towards reward points for royalty type programming. The consumer may first be required to initiate a gaming or mobile type application or App upon his or her consumer computer most typically exemplified by a mobile communications device. By way of the gaming application or App, the user may photograph defined or select graphics placed, printed, or otherwise outfitted upon the retail package. The digital image photograph that contains the coded image and ID of the package may then be communicated to the game server. If the coded entry ID matches the winning ID as variously determined by the game server, the digital image photograph may then be communicated to the authentication server. If the digital image photograph is authenticated, winning messaging may then be communicated to the customer or consumer for redeeming the prize.

The new web-based and purchase driven promotional game and royalty programs enabled by way of the presently described system and method offers many advantages over more traditional or conventional promotional games, such as using a separate game ticket either adhered onto retail packaging or delivered consumers at the point of sale. The game “ticket” according to the present invention is incorporated into the package printing, and thus there is no need to provide extra or separate “game tickets”. The elimination of separate game ticketing is believed to greatly reduce cost and naturally minimizes the environmental impact. Further, with the winning prize preferably randomly generated and assigned by the game server to select consumer entries or “tickets”, every consumer entry or “ticket” is a potential winning entry. This eliminates potential illegal action and reduces fraud.

The reader will further consider that the promotions or gaming enabled by way of the present system and method are not ticket-dependent. Different games can be implemented without altering the package printing and played either at the same time or within different periods of time. The multiple game variations will potentially generate more fun and attract additional consumer participation, and in so doing, drive or develop business traffic, product purchases, and brand loyalty. The interactive nature of the game play between the consumer and the game server permits additional advertising of the brand or cross-brand promotions. The process of the game allows the brand to collect complete marketing information of the game status, game progress and most importantly data mining for business analysis. The data of registered consumers together with their behaviors and stated preferences can help create opportunities for new media-targeted promotions, right-in-time promotions and no/low resistance promotions.

### BRIEF DESCRIPTIONS OF THE DRAWINGS

Other features of the invention will become more evident from a consideration of the following brief descriptions of illustrations submitted in support of the subject invention:

FIG. 1 is a diagrammatic or conceptual depiction of the electronic promotion system according to the present invention basically comprising a mobile communications device outfitted with a mobile application and in communication with a cloud-based data processing environment for processing coded information delivered thereto from a photographable image that provides or serves as a promotion entry.

FIG. 2 is a diagrammatic or conceptual depiction of electronic promotion system initiation methodologies according to the present invention.

FIG. 3 is a diagrammatic or conceptual depiction of electronic promotion system process methodologies according to the present invention.

FIG. 4 is an anterior plan view of a first type of mobile communications device otherwise referred to as a so-called smart phone having a visual display with a generic App icon appearing thereon for application initiation according to the present invention.

FIG. 5 is an anterior plan view of a second type of mobile communications device otherwise referred to as a tablet computer having a visual display with a generic App icon appearing thereon for application initiation according to the present invention.

FIG. 6 is a depiction of a photographable coded image central to the practice of the present invention, the photographable coded image comprising coded information for enabling promotional content governance according to the present invention.

FIG. 6A is a standardized graphic drawing symbol showing a series of parallel lines slanted from upper left to lower right at about 45 degrees relative to the horizontal for denoting the standard color green.

FIG. 6B is a rotated standardized graphic drawing symbol showing a series of parallel lines slanted from upper left to lower right at about 50 degrees relative to the horizontal for denoting a proprietary color green, the proprietary color green being outfitted upon the photographable coded image otherwise depicted in FIG. 6.

FIG. 7 is a retail package outfitted with the photographable coded image otherwise depicted in FIG. 6 according to the present invention.

FIG. 8 is a diagrammatic depiction of an edge-profiled tablet computer with camera feature photographing the photographable coded image as outfitted upon the retail package as otherwise depicted in FIG. 7 according to the present invention.

FIG. 9 is an anterior plan view of the first mobile communications device having a visual display with a digital image photograph appearing thereon as digitally secured or captured from photographing the photographable coded image.

FIG. 10 is an anterior plan view of the second type of mobile communications device having a visual display with a digital image photograph appearing thereon as digitally secured or captured from photographing the photographable coded image as otherwise depicted in FIG. 8.

FIG. 11 is an anterior plan view of the first type of mobile communications device having a visual display with a first textual message displayed thereon for communicating a losing entry according to the present invention.

FIG. 12 is an anterior plan view of the first type of mobile communications device having a visual display with a second textual message displayed thereon for communicating an invalid entry according to the present invention.

FIG. 13 is an anterior plan view of the first type of mobile communications device having a visual display with a third textual message displayed thereon for communicating a winning entry according to the present invention.

### DETAILED DESCRIPTION OF THE PREFERRED SYSTEM AND METHOD

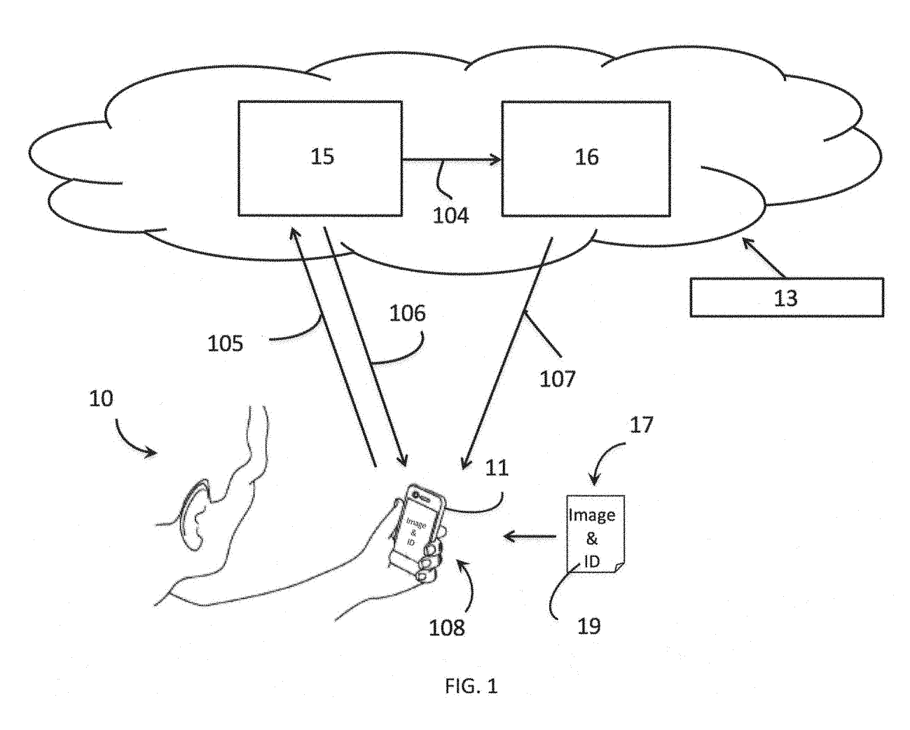

Referring now to the drawings with more specificity, the present invention preferably provides an electronic, computer-based promotion system and method for electronically communicating promotional messages and/or giveaways to consumers. The systemic aspects of the present invention are believed generally and conceptually embraced or depicted in FIG. 1. Referencing FIG. 1, the reader will there consider a consumer as at 10 holding a mobile communications device exemplified or typified by a so-called smart phone 11 (or tablet computer 12 separately and elsewhere illustrated) in communication with and cooperable with a cloud-based data processing environment as diagrammatically depicted at 13.

A smart phone 11 may be described as a mobile phone that performs computer type functions and comprises (a) a visual display 14 that typically doubles as a touchscreen interface, (b) Internet access, and (c) an operating system capable of running downloaded software applications. A tablet computer 12 may be described as a mobile computer with a visual display 14 that also typically doubles or provides a touchscreen interface driven by software processing circuitry. So-called cloud computing or the cloud-based data processing environment 13 is essentially Internet-based computing that pools processing resources and data, including computer networks, servers, data storage, software applications and support services for networked computers (such as smart phones 11 and tablet computers 12) on demand.

Basic to the present invention, the cloud-based data processing environment 13 or similar other computer network provides a game server as at 15 and an authentication server as at 16. The game server 15 operates to govern the promotional program under certain gaming or promotion rules and dictates winning ticket identifiers while maintaining a consumer information database. The game server 15 is preferably in communication and cooperable with the authentication server 16 that primarily functions to validate or authenticate game ticket information as transmitted into the computer-based data processing environment 13 via consumers' mobile communications devices exemplified by smart phones 11 and tablet computers 12 or, more simply, computer(s).

It will be noted that computer networking and the rapid exchange of electronic information enabled thereby have supported a virtual explosion of development in the computing and computer-supported fields of art. The prior art, however, yet perceives a need for an electronic or computer-based promotion system that eliminates the need for separate gaming tickets that may in some cases require further adhesion to retail packaging for delivery to consumers. The present invention provides a completely new platform that revolutionarily changes the traditional mechanism of purchase-related promotion games by allowing complete flexibility in game design and administration, greatly reducing the possibility of illegal foul play, lowering the cost of game implementation, and delivering game performance information.

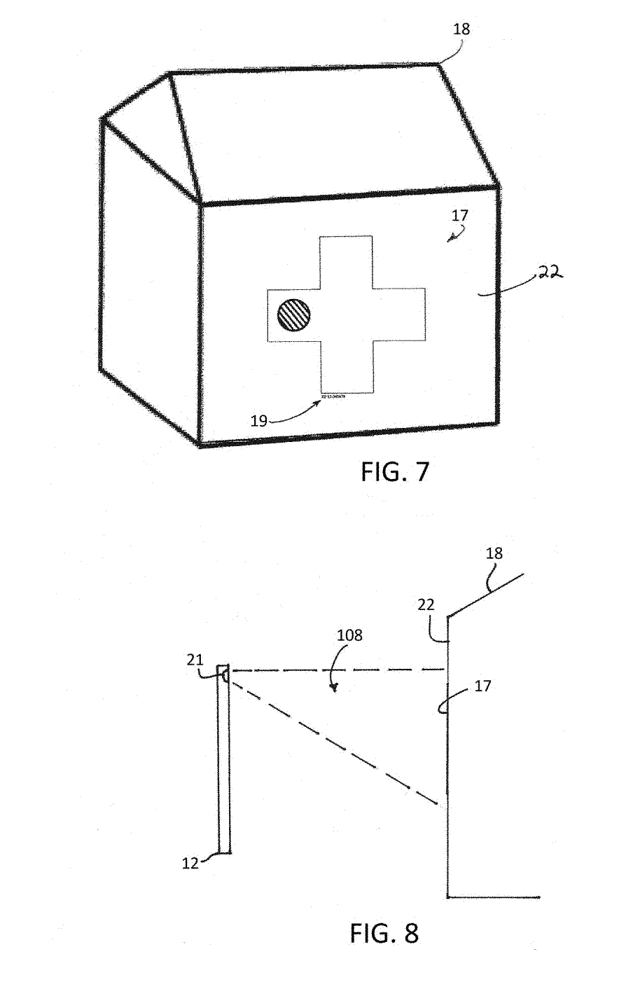

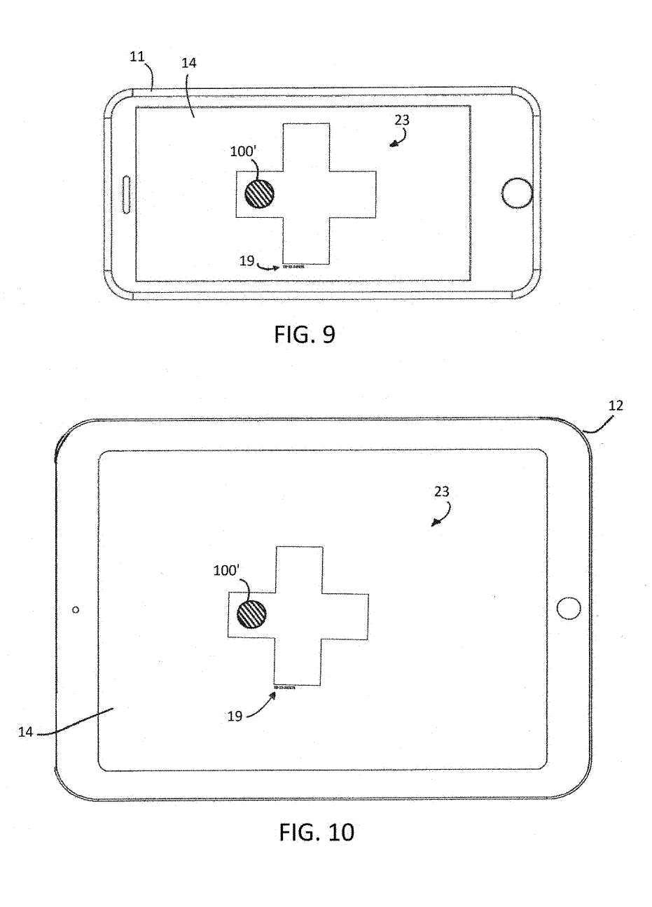

The reader will consider retail packages or packaging and note that such packaging is often printed or outfitted with select graphics that include product imagery, company/brand or logo information, product descriptions, etc. By embedding non-visible and non-duplicable codes into either the brand/logo or product imagery, the present invention enables a new kind of web-based product promotion that allows companies/brands to provide purchase based (1) instant prize win game(s) (2) event promotional game(s) and/or (3) royalty programming. Central to the practice of the present invention are photographable images 17 comprising coded information, including entry-identification information which coded information-bearing images 17 may preferably be outfitted upon retain packaging 18 as generally depicted and referenced in in FIG. 7.

More particularly, each retail package 18 according to the present invention preferably comprises or bears a photographable coded image as at 17. Conceivably, the photographable coded image 17 can either be a product image or brand logo and have a unique package-identifier or ID as at 19 exemplified by a serial number, but conceivably could comprise any series of symbols, letters, or numbers for uniquely identifying the package 18 for supporting the dynamic aspects of the present invention. The identification or ID 19 is different for every package 18 and formed as a part of the complete photographable graphic printed on the package 18, which graphic comprises coded information for authenticating or validating the authenticity of the photographable coded image 17.

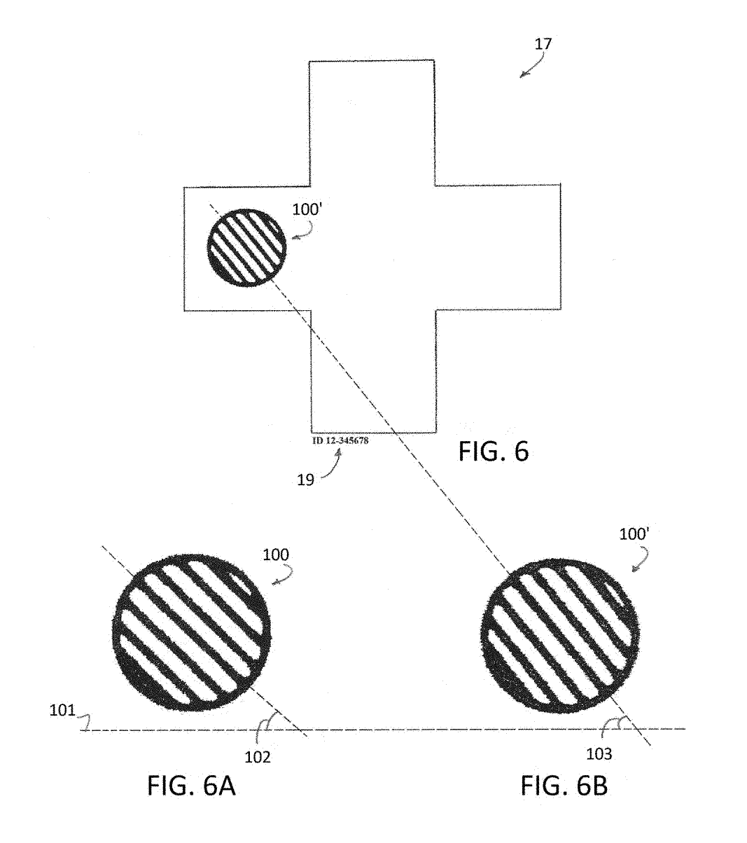

In this last regard, it is contemplated that the image 17 may preferably comprise or contain coded information exemplified by proprietary coloration, which when digitally photographed and processed may provide sufficient digital information for proper authentication. Comparatively, referencing FIGS. 6-6B, for example, the reader will there consider the photographable coded image 17 provided with a proprietary green coloration denoted by a slightly rotated graphic drawing symbol 100′ for green as otherwise set forth under 37 CFR 1.84. The generic color “green” is generally depicted under 37 CFR 1.84 by a series of parallel lines contained in the graphic drawing symbol 100 that are slanted from upper left to lower right at an angle 102 of about 45 degrees relative to a horizontal 101 as generally depicted and referenced in FIG. 6A.

Comparing FIGS. 6 and 6B to FIG. 6A, the reader will consider that the generic “green” coloration otherwise depicted in FIG. 6A has been diagrammatically rendered proprietary by rotation of the graphic drawing symbol 100 about 5 rotational degrees such that the series of parallel lines contained in the graphic drawing symbol 100′ are slanted from upper left to lower right at an angle 103 of about 50 degrees relative to a horizontal 101. The presentation of the diagrammatic color scheme and this discussion is not meant to suggest that the coded information embedded in the photographable coded image 17 is limited to proprietary coloration. Other coded information may relate to image size, image shape, and relative position of image relative to the packaging media. The coded information in any form, however, is photographable, transmittable, and may be separately analyzed, but typically imperceptible to the untrained viewer or passerby.

Once the virtual game ticket or photographable coded image 17 is digitally photographed as at 108, the digital image photograph 23 contains the coded image information inclusive of the image ID 19, and the bundle of information or data is sent or transmitted as at 105 to the cloud-based or computer-based data processing environment 13 in which the entry-identification information or coded information can be extracted from the bundle of data extractable from the digital image photograph 23 and processed via the game server 15. The entry-identification information or coded information can be compared against an information database stored or made available to or within the computer-based data processing environment 13 and either matched to a winning ticket identifier or otherwise determined to denote a non-matching or losing ticket. It is contemplated that the comparative methodology may preferably be governed by the game server 15.

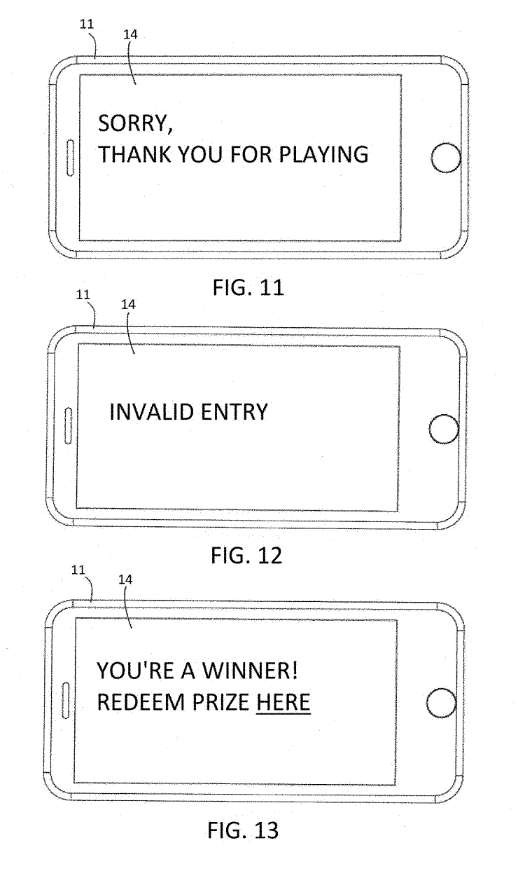

If the entry-identification information or coded information does not match or otherwise denote a winning ticket, a “Thank You for Playing” or similar message may be sent or transmitted as at 106 to the consumer advising the consumer of the entry result, which message may be provided to the consumer upon the visual display 14 of the mobile communications device or consumer computer as generally depicted in FIG. 11. If the entry-identification information or coded information denotes a winning match or a winning match is determined, authentication-code information of the coded information is sent as at 104 for authentication via the authentication server 16.

If the authentication-code information of the coded information is validated or authenticated by the authentication server 16, a “You Win” or similar other prize-bearing message may be sent or transmitted to the consumer as at 107 and as generally depicted in FIG. 13. If the authentication-code information of the coded information cannot be authenticated or has been previously authenticated/redeemed, messages alerting the consumer to those developments may be similarly sent to the consumer computer as generally depicted in FIG. 12 with an “invalid entry” or similar other message.

It will thus be understood that in addition to the photographable coded imagery 17 and an ID 19 outfitted upon the retail package 18, there are preferably at least be two servers, including a game server 15 and an authentication server 16 in the computer-based data processing environment 13 that cooperate to govern electronic promotions according to the present invention. The first server is preferably a game server 15, which is used for defining the game rules, parameters and the prizes, running the games, storing all the registered customers, recording game participation, generating marketing data, etc. The second server is preferably an authentication server as at 16, which processes all authentication-code information of the coded information and imagery involved in the promotional game and are validated as authentic and not duplicated.

Once the electronic promotional game is designed and configured, every retail package 18 may preferably be outfitted with a photographable coded image 17 and thus can potentially become a winning ticket and/or counted towards reward points for a royalty type program. The consumer first initiates an electronic game application or game App generically depicted and referenced at App icon 20. The game App 20 preferably enables camera 21 functionality of the mobile communications device typified by a smart phone 11 or tablet computer 12, and the consumer can photograph as at 108 the photographable coded image 17 preferably outfitted upon an outer portion 22 of the retail package 18.

The digital image photograph depicted at 23 upon the visual display(s) 14 contains the authentication-code information of the coded information (e.g. proprietary green as at slightly rotated graphic drawing symbol 100′) and ID 19 of the package 18 and is preferably first sent or transmitted as at 105 to the game server 15. If the ID 19 matches the winning ID as determined by the game server 15, the digital image photograph 23 may be further sent or transmitted to the authentication server 16. After confirming that the package 18 is authentic by an image analysis process, a winning message can be sent as at 107 to the customer or consumer computer for prize redemption.

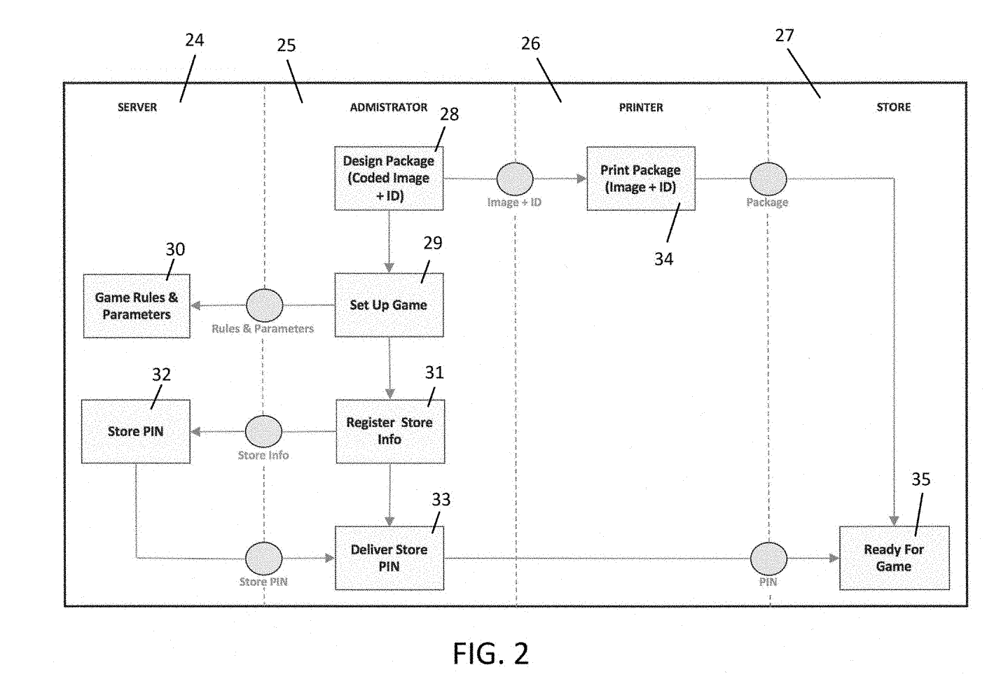

Referencing FIG. 2, the reader will consider a number of layers for electronic promotion or game initiation, including a server side layer as at 24, an administrative layer as at 25, a printer layer as at 26, and a store or retail outlet layer as at 27. Central to the practice of the present invention is the administrative layer 25 which is responsible for package and/or coded imagery design. The coded information is prepared or designed in the form of a photographable coded image 17 as at process 28 and the electronic promotion or game is set up or configured as at process 29. Game rules and parameters are preferably written on the server side 24 as at process 30.

The administrator 25 may further preferably register store or outlet information as at process 31 and create a store or outlet Personal Identification Number or PIN as at process 32 on the server side 24 returnable to the administrator as at process 33. High quality print services are required to properly support the code information contemplated under the package design process 28, and the retail packaging is prepared by way of the high quality print services as at process 34 within the printer layer 26. Once the proposed packaging is approved for further game play or promotional use, the packaging and store or outlet PINs are then delivered or provided to the stores or retail outlets for electronic promotion or game participation as at process 35.

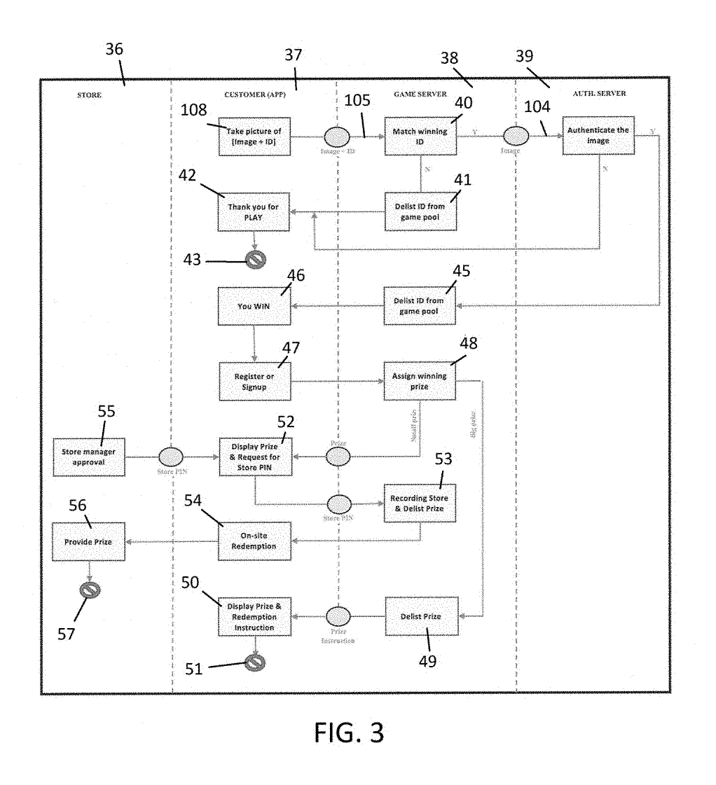

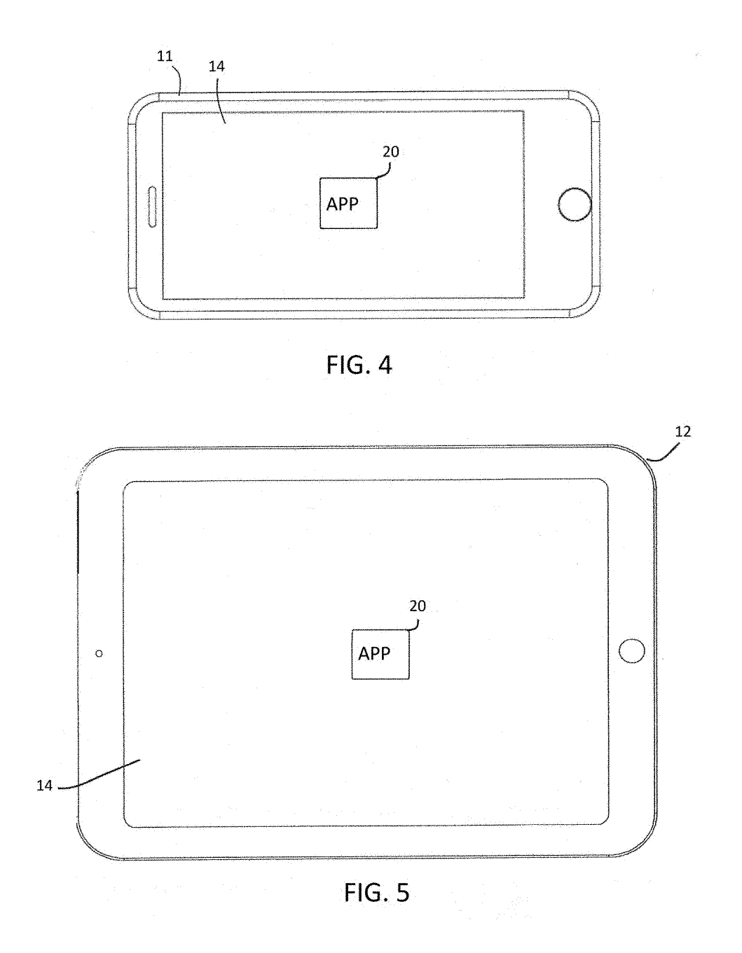

Referencing FIG. 3, the reader will there consider a number of layers of the electronic promotion or game process according to the present invention, including a store or retail outlet layer as at 36; a customer or consumer (App) layer as at 37; a game server layer as at 38; and a authentication server layer as at 38. Central to the game process or methodology is the customer or consumer (App) layer 37. The non-transitory, computer-implementable application or mobile App denoted by App icon 20 is installed on the consumer computer exemplified by a smart phone 11 or tablet computer 12. When the mobile application is initiated, camera 21 functionality is enabled and the consumer may photograph 108 the photographable coded image 17 preferably outfitted upon the retail package 18. A digital image photograph 23 bearing the coded image information and ID 19 is transmitted 105 to the game server 15 or game server layer 28 and processed (i.e. compared to an information database) to determine whether the ID 19 denotes a “winning ticket” or match as at query process 40. If the ID 19 does not match a winning ID, the ID 19 is delisted from the game pool as at process 41 and a message may be sent or transmitted to the consumer computer preferably thanking the consumer for playing as at process 42 and generally depicted in FIG. 11 after which play is terminated as at 43.

If the ID 19 does match a winning ID, the coded information is preferably sent or transmitted 104 to the authentication server 16 or authentication server layer 39 for validation processing as at query process 44. If the coded information cannot be authenticated or is duplicitous, a message is preferably sent or transmitted to the consumer computer preferably indicating an invalid entry attempt or similar other message as at process 42 and generally depicted in FIG. 12 after which play is terminated as at 43. If the coded information is authenticated or validated, the ID 19 is delisted from the game pool as at process 45 and a message is preferably sent or transmitted to the consumer computer indicating a winning entry as at process 46 and as generally depicted in FIG. 13.

A winning entry as denoted at process 46 prompts a consumer registration or sign-up process as at process 47. When consumer registration is complete, a prize may preferably be assigned as at process 48. Relatively small prizes and relatively large prizes may be assigned based on game rules or parameters earlier described, each of which follow a separate process stream. Relatively larger prizes, when assigned, prompt prize delistment as at process 49 and prize display with redemption instructions as at process 50. Once the consumer redeems the relatively larger prize by way of the prize redemption instructions, the methodology may preferably terminate as at termination symbol 51.

Relatively small prizes are typically redeemed on site or in store and thus follow a small prize redemption protocol beginning with prize display and a request for the store or outlet PIN earlier provided to the store or outlet in play as at process 52. The request for the store or outlet PIN may require approval by store manager from the store or outlet layer 36 as at process 55. The store or outlet is recorded by the game server 15 within the game server layer 38; the prize is delisted as at process 53; the prize may preferably be redeemed on-site at the store or outlet as at process 54; and the consumer is provided the prize at process 56 after which promotion or game play terminates as denoted at termination symbol 57.

The new web-based and purchase driven electronic promotional game and royalty program offers many advantages over the traditional or conventional promotional games, such as using a separate game ticket separately delivered to consumers or customers or adhered onto retail packages. Some of the more pertinent or salient advantages of the present invention include the elimination of separate, often adhesively attached game tickets. The game “ticket” according to the present invention is part of the package printing such that the photographable coded image 17 is printed directly or otherwise outfitted upon the retail package 18. Thus, there is no requirement for an extra “game ticket”. The elimination of extra tickets and placing game entry information directly on retail packaging reduces cost and added ticket media thereby contributing to a cleaner environment.

The game server 15 electronically governs game play, and thus the winning prize may be preferably and randomly generated and assigned by the game server 15 to a digital image photograph 23 bearing the coded information and entry ID 19. Thus, every “ticket” or entry can be a winning entry as governed by the random assignments enabled by way of the remote game server 15. The remote game server 15 and random assignment of winning entry ID's helps eliminate potential unlawful action and tends to reduce fraud. Further, since the electronic promotion or game is not ticket dependent, different games or promotions can be implemented without changing package printing and played either at the same time or at a different period in time.

The multiple game variations enabled by way of the single package basis here prefaced has the potential to generate higher entertainment value and attract higher consumer participation. This tends to promote the brand in question and contributes to more business traffic, product purchases and brand loyalty. The interactive nature of the game play between the consumer and the game server 15 also permits additional advertising of the brand or cross-brand promotions. The process of the game allows the brand to collect complete marketing information of the game status, game progress and most importantly data mining for business analysis. The data of registered consumers together with their behavior patterns and preferences opens a door for new media-targeted promotions, right-in-time or real time promotions and no/low resistance promotions.

While the foregoing specifications set forth certain specificity, the same should not be construed as setting forth limits to the invention but rather as setting forth certain preferred embodiments and methodologies. The present invention basically contemplates at least two core aspects of a central invention, including an electronic promotion system and method for communicating promotional messages (e.g. prizes) to consumers.

Viewed systemically, the electronic promotion system is believed to essentially comprise a non-transitory computer-implementable application implementable via at least two computers in communication with one another, including a consumer computer exemplified by a smart phone 11 or tablet computer 12, which consumer computer is in communication with a camera as at 21 and operates to implement the client-side, non-transitory computer-implementable gaming or promotion application separately installed and driven by the consumer computer.

The consumer computer communicates with a computer-based data processing environment as at 13, which computer-based data processing environment 13 is in communication with an information database and further operates to implement and govern a server-side of the non-transitory computer-implementable gaming application installed at the consumer computer or interface. Central to the practice of the present invention is a retail package as at 18 outfitted with a photographable coded image or select graphic as at 17. The photographable image or select graphic essentially comprises coded information that can be transmitted to the computer-based data processing environment 13 and processed as a promotion or game entry.

In this regard, the camera 21 of the consumer computer is operable by way of the gaming application when initiated to photograph the photographable coded image or select graphic 17 for providing or securing a digital image photograph as at 23. The consumer, via the consumer computer, may then communicate the coded information to a game server computer within the computer-based data processing environment 13 via the non-transitory computer-implementable application and the digital image photograph 23. The computer-based data processing environment 13 compares the coded information to the information database for determining whether the coded information is outfitted upon or otherwise associated with a winning retail package or entry.

The coded information outfitted upon the retail packaging 18 may preferably comprise certain retail package identification information as at package ID 19. The game server 15 compares the ID 19 to the information database or otherwise processes the ID 19 according to the game rules and parameters for the purpose of determining whether the coded information, inclusive of the ID 19, is associated with a winning identifier. The computer-based data processing environment 13 preferably comprises both a game server 15 and an authentication server 16 in communication with one another. Certain other coded information (such as size, shape, color, relative position of brand relative to package, etc.) is made available to the electronic promotion system by virtue of the digital image photograph 23 as communicated to the authentication server 16 from the game server 15 for validating the coded information as uniquely authentic and deserving of a prize provided the ID 19 is determined to be a matching or winning ID.

Notably, retain packages are typically mass produced for the purpose of packaging iterative purchases at any given retail outlet or store. In this regard, the present electronic system surely contemplates a series of retail packages all of which are preferably outfitted with a series of photographable coded images or select graphics 17, and each sequential or successive photographable coded image or select graphic comprises package-identifying or package-unique coded information for the purpose of determining winners from amongst a host of participants receiving the outfitted packages.

The game server 15 may optionally either firmly designate assigned winning identifiers for the purpose of matching promotional entries or may randomly assign winner information or identifiers for comparison to the coded information when comparing the coded information to the information database. The random assignment of winning identifier information effectively means the game rules or governance are retail package-independent for enabling simultaneous multi-promotional giveaways or temporally dynamic single promotions. Further, data collected from consumer participation may be data mined for business analysis and use most typically characterized by the provision or delivery of new promotional content to the consumer based on mined data.

Basically, the electronic, computer-based promotion system according to the present invention may be said to comprise or include a non-transitory computer-implementable application implementable via at least two computers in communication with one another; a consumer computer in communication with a camera that implements the a client-sided version of the non-transitory computer-implementable application; and a computer-based data processing environment in communication with an information database and implementing a server-sided version of the non-transitory computer-implementable application; and a photographable coded image preferably outfitted upon retain packaging, but not necessarily so.

The camera is operable to photograph the photographable coded image or select graphic for providing a digital image photograph. The consumer computer communicates the coded information to the computer-based data processing environment via the non-transitory computer-implementable application and the digital image photograph. The computer-based data processing environment compares the coded information to the information database for determining whether the coded information is outfitted upon or otherwise associated with a winning photographable coded image preferably outfitted upon a retail package.

Considered methodologically, the present invention provides an electronic, computer-based promotion method for communicating promotional messages or content to a consumer. The promotion methodology according to the present invention may be said to preferably and essentially comprise a preliminary step of providing a photographable coded image or select graphic, which photographable coded image or select graphic comprises coded information. A consumer may then digitally photograph the photographable coded image or select graphic with a computer-based camera thereby providing or creating a digital image photograph. Being operable by way of a computer-implementable gaming application implemented by a computer, the digital image photograph bearing coded information is communicated to a first server exemplified by the game server 15 at which time the coded information is compared to an information database via the first server for determining whether the coded information is outfitted upon or otherwise associated with a winning entry piece preferably exemplified by a retail package 18 outfitted with a photographable coded image 17 or select graphic.

In this last regard, it will thus be understood that the provided photographable coded image is preferably outfitted upon a retail package and that the coded information preferably comprises certain retail package identification information. If the retail package identification information is determined to be affiliated with a winning identifier, the coded information may be communicated to a second server (i.e. an authentication server as at 16) for validating the coded information as uniquely authentic. The step of communicating the coded information to the authentication or second server may preferably comprise the step of transmitting the digital image photograph thereto whereafter the photograph itself may be processed at the second server for communicating the entry-authenticating coded information thereto.

The step of comparing the coded information via the first server to the information database comprises may preferably comprise the step of randomly assigning winner information. The game rules or parameters governing promotion or game play may preferably be retail package independent for enabling simultaneous multi-promotional giveaways or temporally dynamic single promotions. Data may be mined from consumer registration information for the purpose of business analysis and use most commonly characterized by advertising or communicating new promotional content to the consumer derived from the mined data.

The promotion method may further preferably comprise the step of communicating a winning message to the consumer for prize redemption, which step of communicating the winning message to the consumer may be delivered to consumer via a visual message displayed upon the visual display of the consumer's computer. Accordingly, although the invention has been described by reference to certain preferred and alternative methodologies, it is not intended that the novel arrangements be limited thereby, but that modifications thereof are intended to be included as falling within the broad scope and spirit of the foregoing disclosures, the appended drawings submitted in support of these specifications, and the following claims.

What is claimed is:

1. A computer-implementable promotion system for communicating promotional content to consumers, the promotion system comprising:
a non-transitory, computer-implementable application implementable via at least two computers in communication with one another;
a consumer computer, the consumer computer being in communication with a camera and implementing a client-sided version of the non-transitory computer-implementable application; and
a computer-based data processing environment, the computer-based data processing environment being in communication with an information database and implementing a server-sided version of the non-transitory computer-implementable application; and
at least one retail package, the at least one retail package being outfitted with a photographable coded image, the photographable coded image comprising entry-identification information;
the camera being operable to photograph the photographable coded image for providing a digital image photograph, the consumer computer for communicating the entry-identification information to the computer-based data processing environment, the computer-based data processing environment for comparing the entry-identification information to the information database for determining whether the entry-identification information is outfitted upon a winning entry piece.

2. The promotion system of claim 1 wherein the entry-identification information comprises authentication-code information.

3. The promotion system of claim 2 wherein the computer-based data processing environment comprises a game server and an authentication server in communication with one another, the authentication-code information being communicable to the authentication server from the game server for validating the authentication-code information as uniquely authentic.

4. The promotion system of claim 1 wherein a series of retail packages are outfitted with a series of photographable coded images, each photographable coded image comprising unique entry-identification information.

5. The promotion system of claim 3 wherein the computer-based data processing environment processes the authentication-code information as delivered thereto via the digital image photograph.

6. The promotion system of claim 1 wherein the computer-based data processing environment randomly assigns winner identification information, the randomly assigned winner identification information being compared to the entry-identification information.

7. The promotion system of claim 1 wherein the computer-based data processing environment is governed by promotion rules, the promotion rules being retail package independent.

8. The promotion system of claim 1 wherein the computer-based data processing environment is operable to mine data from consumer information for business analysis.

9. The promotion system of claim 8 wherein the computer-based data processing environment is operable to communicate new promotional content to the consumer based on mined data.

10. An electronic promotion system for communicating promotional content to consumers, the promotion system comprising:
a non-transitory, computer-implementable application;
a consumer computer, the consumer computer being in communication with a camera;
a computer-based data processing environment; and
a photographable coded image, the photographable coded image comprising entry-identification information;
the camera being operable to photograph the photographable coded image for providing an image photograph, the consumer computer for communicating the entry-identification information to the computer-based data processing environment, the computer-based data processing environment for determining whether the entry-identification information is associated with a winning entry.

11. The promotion system of claim 10 wherein the entry-identification information comprises authentication-code information.

12. The promotion system of claim 11 wherein the computer-based data processing environment comprises a game server and an authentication server in communication with one another, the authentication-code information being communicable to the authentication server from the game server for validating the authentication-code information as uniquely authentic.

13. The promotion system of claim 10 wherein the computer-based data processing environment processes the authentication-code information as delivered thereto via the image photograph.

14. The promotion system of claim 10 wherein the computer-based data processing environment randomly assigns winner identification information, the randomly assigned winner identification information being compared to the entry-identification information for determining whether the entry-identification information is associated with the winning entry.

15. An electronic promotion method for communicating promotional content to a consumer, the electronic promotion method comprising the steps of:
providing a photographable coded image, the photographable coded image comprising entry-identification information;
photographing the photographable coded image with a camera thereby providing an image photograph;
communicating the entry-identification information to a first server; and
comparing the entry-identification information to an information database via the first server for determining whether the entry-identification information denotes a winning entry.

16. The promotion method of claim 15 wherein the provided photographable coded image is outfitted upon a retail package and comprises authentication-code information.

17. The promotion method of claim 16 comprising the step of communicating the authentication-code information to a second server, the second server for validating the authentication-code information as uniquely authentic.

18. The promotion method of claim 15 wherein the step of comparing the entry-identification information to an information database comprises the step of randomly assigning winner identification information for comparison.

19. The promotion method of claim 15 wherein the computer-based data processing environment is governed by promotion rules, the promotion rules being retail package independent.

20. The promotion method of claim 15 comprising the step of data mining promotion method activity for business analysis, promotional content being communicated to the consumer based on mined data.
